(19) United States
(12) Patent Application Publication
(10) Pub. No.: US 2019/0133860 A1
(43) Pub. Date: May 9, 2019

(54) BIRTHING HARNESS

(71) Applicant: University of Utah, Salt Lake City, UT (US)

(72) Inventor: Robert Kirkham, Salt Lake City, UT (US)

(21) Appl. No.: 16/125,277

(22) Filed: Sep. 7, 2018

Related U.S. Application Data
(60) Provisional application No. 62/555,476, filed on Sep. 7, 2017.

(51) Int. Cl. A61G 7/10

(52) U.S. Cl. CPC A61G 7/1051; A61G 7/1044; A61G 7/1001

(57) ABSTRACT

A birthing harness birthing harness for supporting a female during birthing is disclosed and described. The birthing harness comprises: at least one left thigh strap configured to fit around a left thigh of a female; at least one right thigh strap configured to fit around a right thigh of the female; at least one rear torso strap coupled to the at least one left and right thigh straps; and at least one upper body strap coupled to the at least one rear torso strap and configured to fit around an upper portion of the female. Various attachment devices can be coupled to respective straps coupling the birthing harness to an overhead support mechanism via support lines such that at least some of the weight of the female is supported by the overhead support mechanism via the birthing harness while in a squatting or laying position.

### RELATED APPLICATION(S)

This application claims priority to U.S. Provisional Application Ser. No. 62/555,476, filed Sep. 7, 2017, which is hereby incorporated herein by reference in its entirety.

### GOVERNMENT INTEREST

None.

### BACKGROUND

For many women, the most optimal and more natural position during the birthing process is having the mother in a squatting position and not lying on her back. Squatting encourages rapid descent, uses gravity, can increase rotation of the baby, allows freedom to shift weight for comfort, allows excellent perineal access for health professionals, facilitates fetal circulation, may increase pelvis diameter by as much as two centimeters, and can require less bearing down effort.

Descent is encouraged by the squatting position and the mother's thighs keep the baby well aligned. The biggest problem that comes with squatting is it can be quickly tiring for the mother.

Lying on the back in the Lithotomy position can cause lower back pain and nerve pain for those women who have not had an epidural and can be uncomfortable while bearing down. It can also be uncomfortable while bearing down both for women who have had an epidural or have not had an epidural. Most women may not have the upper leg strength to be able to stay in the squatting position.

### SUMMARY

A birthing harness for supporting a female during birthing comprises: at least one left thigh strap configured to fit around a left thigh of a female, and comprising a first attachment device; at least one right thigh strap configured to fit around a right thigh of the female, and comprising a second attachment device at least one rear torso strap coupled to the at least one left and right thigh straps, and configured to extend along a back torso of the female, the at least one rear torso strap comprising a third attachment device; and at least one upper body strap coupled to the at least one rear torso strap and configured to fit around an upper body portion of the female. Each of the first, second, and third attachment devices is coupleable to a support line of an overhead support mechanism such that at least some of the weight of the female is supported by the overhead support mechanism via the birthing harness.

In one example, the at least one upper body strap comprises a left and right shoulder straps each configured to fit around a shoulder of the female.

In one example, the birthing harness is removably coupled to the female by a plurality of quick-release attachment mechanisms coupled to at least some of the straps.

In one example, a birthing harness for supporting a female during birthing comprises: a pair of left thigh straps configured to fit around a left thigh of a female, each left thigh strap comprising a left thigh attachment device coupleable to an overhead support mechanism; a pair of right thigh straps configured to fit around a right thigh of a female (each right thigh strap comprises a right thigh attachment device coupleable to the overhead support mechanism); a pair of rear torso straps coupled to the pairs of left and right thigh straps (each rear torso strap comprises a rear attachment device coupleable to the overhead support mechanism); and a pair of shoulder straps coupled to pair of rear torso straps and configured to fit around shoulders of the female.

In one example, the right thigh attachment devices and the left thigh attachment devices are oriented forward of the female's thighs, and the rear attachment devices are oriented rearward of the female's back.

The birthing harness disclosed herein can facilitate increased support and options for birthing in a squatting position (or laying position) while suspended in air (or at least partially suspended in air). It places the baby in a more favorable more natural position for childbirth, which is squatting, or even laying on the back or side. It can place the mother in a more comfortable squatting position throughout the birthing process, while also allowing for adjustment of the mother's degree of support. It allows the doctor to be in a position that, when seated, does not put strain on the doctor's lower back.

Cesarean sections can be more dangerous and more expensive surgeries during birth. By using the disclosed birthing harness to place the mother in a squatting position (or laying position) and allowing for gravity to assist, this minimizes the possibility of having to perform a Cesarean section. The baby more easily works its way down the birthing canal while the mother is in a squatting position. Should an eversion procedure be required with the baby, the baby can have a greater tendency to stay in the proper position placed by the doctor, instead of reverting back to its previously unwanted position (e.g. breech), if the mother is in a squatting position and at least partially supported by the birthing harness disclosed herein.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 illustrates a side view of a female wearing a birthing harness and in a squatting position as supported by an overhead support mechanism, in accordance with an example of the present disclosure.

FIG. 2 illustrates a front view of FIG. 1, in accordance with an example of the present disclosure.

FIG. 3 illustrates the birthing harness of FIGS. 1 and 2 removed from the female and spread out flat on a ground surface, in accordance with an example of the present disclosure.

FIG. 4 illustrates a side view of the female wearing the birthing harness of FIG. 1 and in a laying position, in accordance with an example of the present disclosure.

FIG. 5 illustrates an alternative variation of a birthing harness spread out on a flat surface, in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a strap” includes reference to one or more of such features and reference to “securing” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Birthing Harness

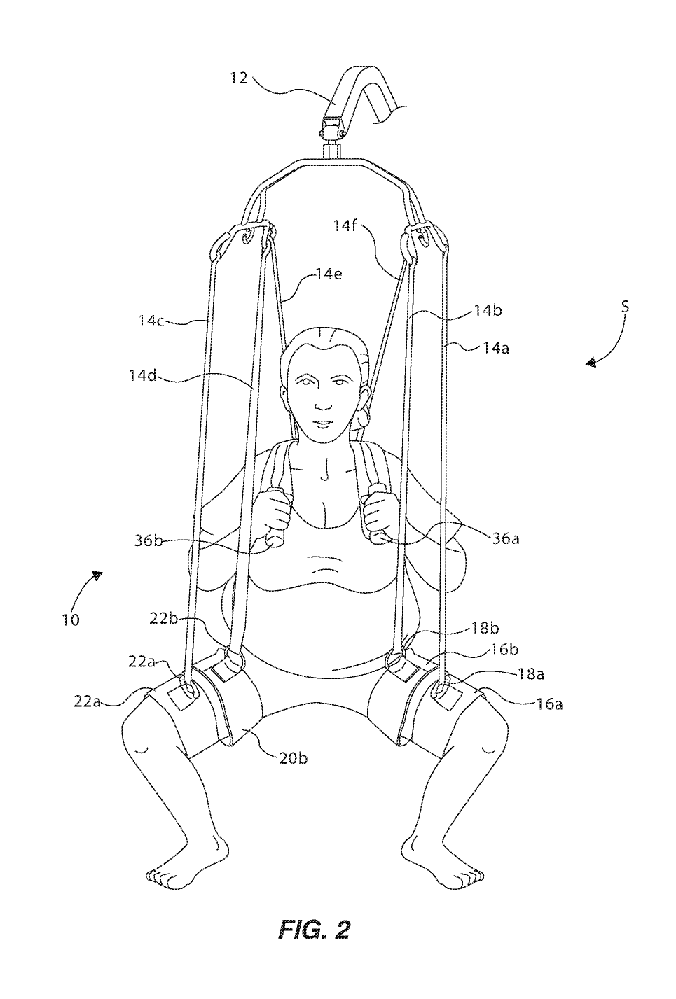

The birthing harness disclosed herein assists women with their upper leg strength by placing them in a favorable, supported, and minimally weight bearing squatting position (or laying position). In this birthing harness the mother may not be completely suspended by the birthing harness (i.e., the birthing harness supporting her entire weight). Rather, she can be at least partially supported by four lines (e.g., cables, straps, etc.) coupled to an overhead support structure, where two lines can be attached to rings on the back of the birthing harness in the area of each scapula, and one or more to each leg on top of the left and right thighs (see e.g., FIG. 2). For example, a Hoyer lift can be used to attach the birthing harness (via support lines) and to support at least some of the weight of the mother. The birthing harness can include handles on the yoke of the birthing harness that allow the mother to hold while bearing down to give birth. The back of the birthing harness can also be open to allow for placement and use of an epidural.

Should an emergency cesarean section need to be performed during birth, the birthing harness can include a plurality of quick side-release male to female strap buckles for removing the birthing harness from the mother, such as discussed below.

Moreover, doctors can experience long term back pain in the Lumbar region when delivering babies while the mother is lying down on a birthing bed. According to the United States Occupational Safety and Health Administration (OSHA), back injuries account for a significant amount of human suffering, loss of productivity, and economic burden on compensation and insurance systems. Back disorders are one of the leading causes of disability for people in their working years and the frequency and economic impact of back injuries and disorders on the work force are expected to increase over the next several years. OSHA reports that factors associated with back disorders are reaching while lifting, bad body mechanics, poor design of job or work stations, poor posture (how one sits or stands), and maintaining bent postures.

The birthing harness disclosed herein can allow for the mother to still have her feet in stirrups while placing her in a squatting position above the doctor so he can be in an upward seated position (instead of a bent seated position, hunching the lower back).

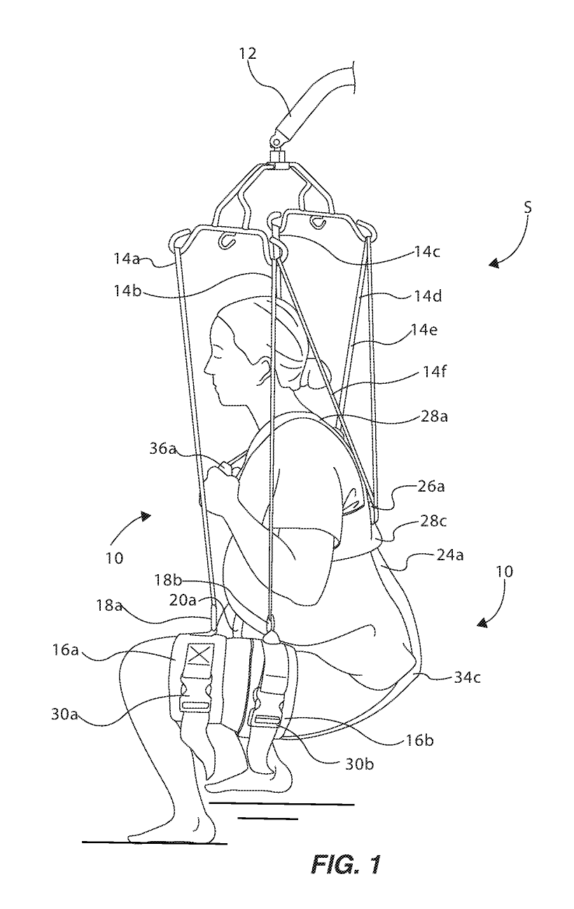

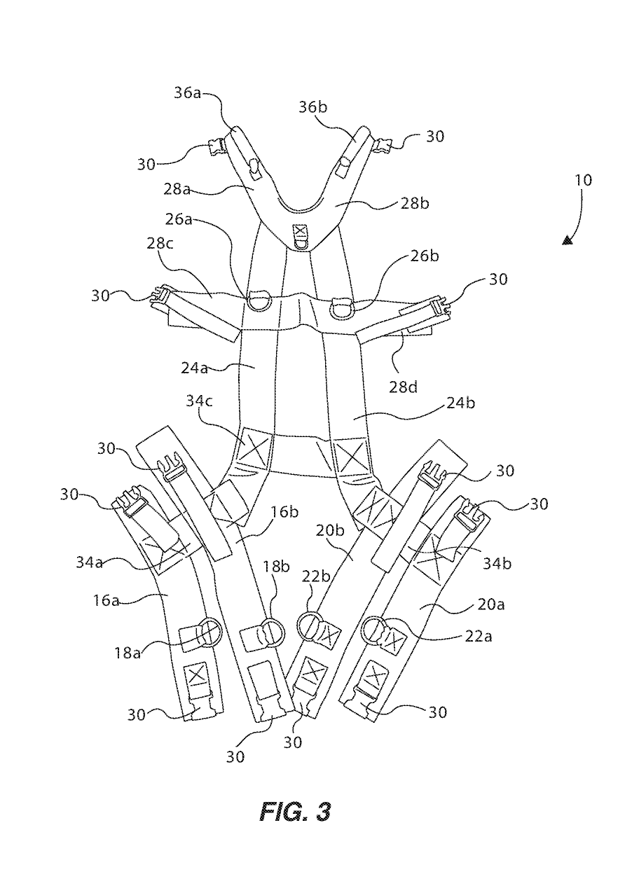

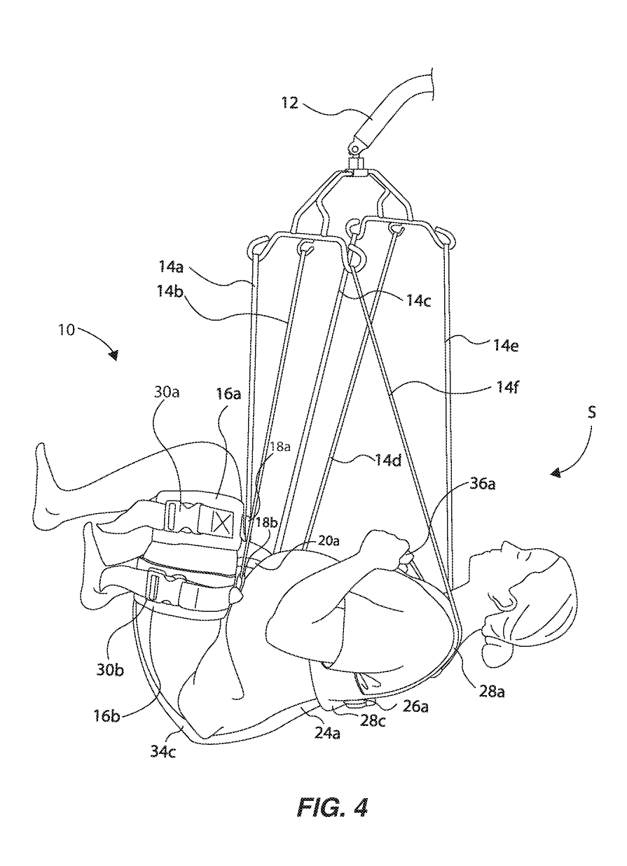

With reference to FIGS. 1-4, a birthing harness 10 is disclosed in accordance with an example of the present disclosure. FIGS. 1 and 2 show a birthing harness system S showing a female wearing the birthing harness 10 while in a squatting position, where at least some of her weight is supported by a support mechanism 12 via support lines 14 removably coupled to the birthing harness 10 (the female may be supporting some of her weight by placing her feet on the ground, as in FIG. 1). FIG. 3 shows the birthing harness 10 spread-out flat on a ground surface, to better illustrate the various features discussed herein. And FIG. 4 shows the birthing harness system S showing the female wearing the birthing harness 10 while in a laying position (either fully suspended, or partially supported by a birthing bed).

In one example, the birthing harness 10 can comprise a pair of left thigh straps 16a and 16b configured to fit around a left thigh of the female, which can each comprise a left thigh attachment device 18a and 18b (a first set) coupled to the overhead support mechanism 12 via support lines 14a and 14b. The birthing harness 10 can comprise a pair of right thigh straps 20a and 20b configured to fit around a right thigh of the female, which can each comprise a right thigh attachment device 22a and 22b (a second set) coupled to the overhead support mechanism 12 via support lines 14c and 14b. In one alternative, a pair of front support lines (not shown) can be optionally secured to either (but not both) of forward thigh straps 16a and 20a or rearward thigh straps 16b and 20b. By securing support lines to forward thigh straps 16a and 20a the mother can be more fully supported. Alternatively, by securing support lines to the rearward thigh straps 16b and 20b the mother can have less support and increased movement.

The birthing harness 10 can comprise a pair of rear torso straps 24a and 24b coupled to the pairs of left and right thigh straps 16a, 16b, 20a, and 20b. Each rear torso strap 24a and 24b can comprise a rear attachment device 26a and 26b (a third set; see FIG. 3) coupleable to the overhead support mechanism 12 via support lines 14e and 14f. The rear attachment devices can be proximate or near the scapula area of the female. Note that the various support lines discussed herein are shown in the figures as terminating at various structural support rings of the overhead support mechanism 12. However, each support line can be fixedly hooked to the structural support rings, and can have adjustment devices on the support lines for adjusting the lengths of the support lines. Alternatively, the support lines can be traversed through the structural support rings and adjustably coupled to another part of the overhead support mechanism, such as a pulley system having adjustment devices for changing the length of each support line. Either adjustment system can provide a means for quickly changing the length of each support line to accommodate for different heights of each strap, and therefore different sized of females, birthing beds, stirrups, etc. Providing adjustable support lines also allows the female to be able to lie on her back, or lay sideways in either direction, for example, during resting in between contractions, prior to a bearing down stage, or for comfort.

The birthing harness 10 can comprise pair of shoulder straps 28a and 28b coupled to the pair of rear torso straps 24a and 24b, and configured to fit around respective left and right shoulders of the female (i.e., under the armpit and over the shoulder). In another example, the shoulder straps 28a and 28b can be replaced with an upper body strap (not shown), for instance, that wraps around an upper body portion of the female (whether under the arms and around the torso, or over a shoulder).

Notably, the left thigh attachment devices 18a and 18b and the right thigh attachment devices 22a and 22b are coupled to respective thigh straps at a forward position (FIG. 1) such that they are oriented forward of the female's thighs. Thus, at least a portion of each attachment device 18a, 18b, 22a, and 22b can intersect a respective parasagittal plane of the female's legs in a forward position relative to the frontal plane of the female (i.e., forward of the thighs). The rear attachment devices 26a and 26b can be oriented rearward of frontal plane (i.e., about or behind the female's back), such that the female can be positioned in a squatting position when supported by the overhead support mechanism 12 (or in the laying position of FIG. 4). As discussed above, such squatting position is advantageous for a more natural birthing position for the mother and the baby. Although not shown here, the support lines can be adjusted such that the female can lie on her back, or lay sideways in either direction, for example, during resting in between contractions, prior to a bearing down stage, or comfort.

As best shown in FIG. 3, in one example the birthing harness can comprise a plurality of quick-release attachment mechanisms 30 coupled to the various respective straps such that the birthing harness 10 can be quickly, removably coupled to the female. Thus, each of the left and right thigh straps and the shoulder straps can comprise a quick-release mechanism, such as side-release buckles, as shown. Other coupling mechanisms can be used, such as but not limited to, hook-and-loop fasteners, buttons, snaps, hooks, clips, detents, etc.

In one example, each strap (left and right thigh straps and shoulder straps) can be size adjustable via the quick-release attachment mechanisms by slidably adjusting a length of the respective strap with manual adjustment. In one example, each attachment device discussed herein can comprise a metal ring attached to a respective strap via sewing fabric loops through the metal ring, although other attachment devices can be used, like fabric hoops, metal hooks, or other devices that can support the weight of a female.

The pair of left thigh straps 16a and 16b can be oriented generally parallel to each other along their longitudinal lengths, and can be coupled together by a first coupling strap 34a, as shown in FIG. 3. Likewise, the pair of right thigh straps 20a and 20b can be oriented generally parallel to each other along their longitudinal lengths, and can be coupled together by a second coupling strap 34b. The first and second coupling straps 34a and 34b can extend orthogonally from respective thigh straps and be coupled to a respective torso strap 24a and 24b. Alternatively, the left and right pairs of thigh straps can include or consist of a single left thigh strap and a single right thigh strap, or even three or more straps on each thigh.

The torso straps 24a and 24b can extend generally vertical along the female's back and generally parallel to each other along their longitudinal lengths, or at least spatially separated from each other. An upper torso strap 28c can be oriented along the torso straps 24a and 24b and spaced apart from the shoulder straps 28a and 28b to provide upper body support. A lower area of the torso straps 24a and 24b can be coupled to each other by a third coupling strap 34c. More specifically, the third coupling strap 34c can be oriented at or near the sacrum to provide additional support of the female's weight. The sacrum strap 34c can generally be spaced apart from the shoulder straps 28a and 28b so as to locate the sacrum strap 34c at the sacrum during use. Optionally, the distance between the shoulder straps and sacrum strap can be adjustable to allow for various size individuals. Distance adjustment mechanisms can allow the shoulder straps 28a and 28b, the upper torso strap 28c, and/or the sacrum strap 34c to be moved relative to one another. For example, the torso straps 24a and 24b can include adjustable length. Alternatively, or in addition, the shoulder straps 28a and 28b, upper torso strap 28c, and/or sacrum strap 34c can be moveable or slidable along the torso straps 24a and 24b. An upper area of the torso straps 24a and 24b can be coupled to each other by arm pit ends of each shoulder strap 28a and 28b. Upper ends of the torso straps 24a and 24b terminate, and can be coupled to ends of each shoulder strap 28a and 28b (ends that couple to the other ends of each shoulder strap via quick-release devices 30). A portion of the shoulder straps can be formed as a yoke that wraps around the backside of the neck and over respective shoulders, as shown.

FIG. 4 shows the female wearing the birthing harness 10 while in a laying position on her back (e.g. during resting periods or other reasons). The position of female wearing the birthing harness 10 can be adjusted by adjusting the length of one or more of the support lines 14a-f, so that she may lie on her back, whether suspended in midair, or laying on a bed where some of her weight is supported by the overhead support structure 12 via the birthing harness 10. In this position, the female may also have her legs in stirrups, so that at least some of the weight of her legs is supported by the left and right thigh straps, which may better position the female for a birthing procedure. Additional attachment devices along the inner or other sides of the thighs can be incorporated with the left and right thigh straps, and the support lines can be attached thereto, to better support the legs from the sides. Likewise, additional attachment devices can be incorporated about the front torso area of the female, such as on the front of the torso and/or shoulder straps near the handles, so that the support lines can extend up and away from the female's chest area, which may also better support the female and prevent the support lines from causing discomfort or interfering with supporting weight.

Each strap can be a flexible woven fabric, leather, cloth, or other suitable material. Generally, the straps can be flexible and sufficiently strong to support a mother's weight (e.g. typically at least 200 to 300 pounds load capacity) without damage. Each attachment device can be attached to a respective strap via a fabric loop sewn or otherwise attached to the respective strap. Each coupling strap can be coupled to respective straps by a sewn seem, adhesive, or other suitable fastening device.

In one example, a handle or grip device 36a and 36b can be coupled to each of the shoulder straps 28a and 28b for the female or a service provider to grip for leverage, and to assist raising and lowering the female.

In one example, the overhead support mechanism 12 can be a Hoyer lift, as commercially available, although other lift systems can be used such as, but not limited to, ceiling mounted track systems, bed mounted lift systems, and the like. Other examples include a squat bar, tripod, or some other mobile support structure for deployment out of hospital settings. The support lines 14 can be removably coupled to respective attachment devices via hooks at the end of the support lines. The support lines 14 can also be adjustable in length so that the female or service provider can adjust the height of the female from the ground, and consequently the amount of weight the birthing harness is supporting.

Although not shown here, the rear torso straps 24a and 24b can have an adjustment device to adjust a length of each torso strap to fit different size females. Although not shown here, a thigh attachment device can be coupled to one side of at least one of the left or right thigh straps, and optionally coupled to a support line. In this manner, the support line can be wrapped around a support hook of the overhead support mechanism and then down toward the female. Thus, the female, while laying on her side, can pull on the support line the support line to lift one of her legs. Alternatively, the thigh attachment device can be a handle which would allow the female or an assistant to lift the leg.

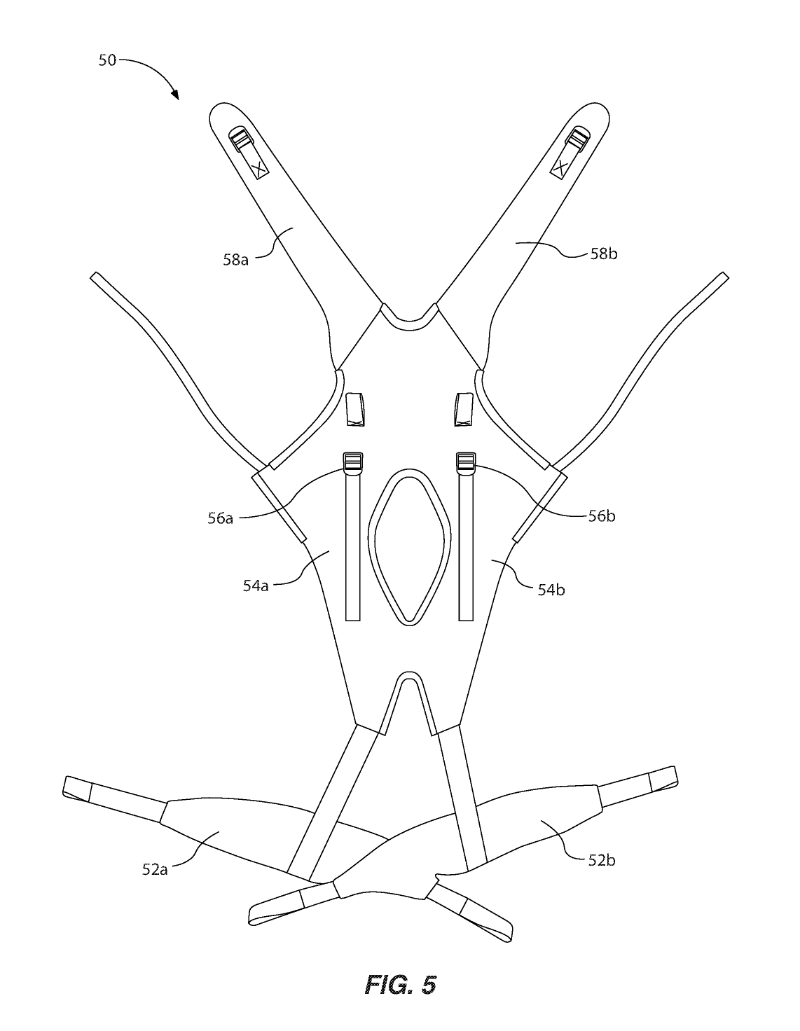

In another alternative, FIG. 5 illustrates a birthing harness 50 which includes a pair of torso straps 54a, 54b which collectively form a torso support. Rear attachment devices 56a, 56b can be used to couple to an overhead support mechanism. The torso support can also be coupled to a left thigh strap 52a and a right thigh strap 52b. As with earlier descriptions, the rear attachment devices can be proximate or near the scapula area of the female.

The birthing harness 50 can also include a pair of shoulder straps 58a and 58b coupled to the pair of torso straps 54a, 54b via the torso support, and configured to fit around respective left and right shoulders of the female (i.e., under the armpit and over the shoulder). In this example, the torso support can be formed of a material such as, but not limited to, nylon (e.g. 70 denier rip-stop nylon) or the like. Similarly, a 2″ polyester belt webbing can be used to form straps. Other features and relationships described in connection with FIG. 1-4 can also be integrated into the birthing harness of FIG. 5.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A birthing harness for supporting a female during birthing, comprising:
at least one left thigh strap configured to fit around a left thigh of a female, and comprising a first attachment device;
at least one right thigh strap configured to fit around a right thigh of the female, and comprising a second attachment device;
at least one rear torso strap coupled to the at least one left and right thigh straps, and configured to extend along a back torso of the female, the at least one rear torso strap comprising a third attachment device; and
at least one upper body strap coupled to the at least one rear torso strap and configured to fit around an upper body portion of the female,
wherein each of the first, second, and third attachment devices is coupleable to a support line of an overhead support mechanism, such that at least some of the weight of the female is supported by the overhead support mechanism via the birthing harness.

2. The birthing harness of claim 1, wherein the at least one left thigh strap comprises a pair of left thigh straps each configured to fit around the left thigh of the female, and wherein the at least one right thigh strap comprises a pair of right thigh straps each configured to fit around the right thigh of the female.

3. The birthing harness of claim 1, wherein the upper body portion of the female is shoulders of the female, and wherein the at least one upper body strap comprises a left and right shoulder straps each configured to fit around a shoulder of the female.

4. The birthing harness of claim 1, wherein the at least one rear torso strap comprises left and right rear torso straps coupled to each other via a sacrum strap, wherein the left rear torso strap is coupled to the at least one left thigh strap, and wherein the right rear torso strap is coupled to the at least one right thigh strap, and the sacrum strap is oriented proximate the at least one left thigh strap and the at least one right thigh strap so as to support a sacrum of the female during use.

5. The birthing harness of claim 1, wherein the first and second attachment devices are coupled to respective left and right thigh straps at a forward position of the thighs of the female, such that, when the female is wearing the birthing harness as supported by the overhead support mechanism, the female is positionable in at least one of a squatting position or back-laying position.

6. The birthing harness of claim 1, wherein the third attachment device is coupled to the at least one rear torso strap and positionable about the back of the female, such that, when the female is wearing the birthing harness as supported by the overhead support mechanism, the female is positionable in a squatting position.

7. The birthing harness of claim 1, wherein the first, second, and third attachment devices are coupled to respective straps of the birthing harness at respective positions about the birthing harness, such that, when the female is wearing the birthing harness as supported by the overhead support mechanism, the female is positionable in at least one of a squatting position or back-laying position.

8. The birthing harness of claim 1, wherein the at least one left thigh strap comprises a pair of left thigh straps, the at least one right thigh strap comprises a pair of right thigh straps, and the at least one upper body strap comprises a pair of shoulder straps each configured to fit around a respective shoulder of the female, wherein each pair of straps comprises a pair of attachment devices, such that each strap supports one attachment device.

9. The birthing harness of claim 1, wherein each of the first, second, and third attachment devices comprises a metal ring attached to a respective strap.

10. The birthing harness of claim 1, wherein the birthing harness is removably coupled to the female by a plurality of quick-release attachment mechanisms coupled to at least some of the straps.

11. The birthing harness of claim 1, further comprising a pair of handles coupled to the at least one body strap at a forward position of the birthing harness, such that the female wearing the birthing harness can grip the pair of handles while wearing the birthing harness.

12. The birthing harness of claim 1, wherein the birthing harness size is adjustable by a plurality of strap adjustment devices coupled to at least some of the straps.

13. The birthing harness of claim 1, further comprising a thigh attachment device coupled to at least one of the left or right thigh straps, wherein the thigh attachment device is a handle to allow the female to lift one of her legs while laying on her side.

14. The birthing harness of claim 1, wherein the at least one rear torso strap is adjustable in length.

15. The birthing harness of claim 1, wherein the first, second, and third attachment devices are positioned about the birthing harness such that, when the female is wearing the birthing harness as supported by the overhead support mechanism, the female's spine is oriented generally vertical while the female is in a squatting position.

16. The birthing harness of claim 1, wherein:
the at least one left thigh strap comprises a pair of left thigh straps configured to fit around the left thigh of the female, each left thigh strap comprising a left thigh attachment device coupleable to an overhead support mechanism, and
the at least one right thigh strap comprises a pair of right thigh straps configured to fit around a right thigh of a female, each right thigh strap comprising a right thigh attachment device coupleable to the overhead support mechanism, and
the at least one rear torso strap comprises a pair of rear torso straps coupled to the pairs of left and right thigh straps, each rear torso strap comprising a rear attachment device coupleable to the overhead support mechanism, and
the at least one upper body strap comprises a pair of shoulder straps coupled to the pair of rear torso straps, and each configured to fit around shoulders of the female.

17. The birthing harness of claim 16, further comprising a plurality of quick-release attachment mechanisms removably coupling the birthing harness to the female.

18. The birthing harness of claim 16, wherein the right thigh attachment devices and the left thigh attachment devices are oriented forward of the female's thighs, and wherein the rear attachment devices are oriented rearward of the female's back, such that the female is positionable in either a squatting or laying position when supported by the overhead support mechanism.

19. The birthing harness of claim 16, further comprising an overhead support mechanism and a plurality of adjustable support lines coupled to the overhead support mechanism, each support line is coupleable to a respective attachment device.

20. The birthing harness of claim 16, wherein the right thigh attachment device and the left thigh attachment device are each oriented forward of the female's thighs, and wherein the rear attachment device is oriented rearward of the female's back, such that the female is positionable in either a squatting or laying position when supported by the overhead support mechanism.
